(19) United States
(12) Patent Application Publication
(10) Pub. No.: US 2021/0151243 A1
(43) Pub. Date: May 20, 2021

(54) ELECTROMAGNETICALLY EXCITABLE COIL

(71) Applicant: Robert Bosch GmbH, Stuttgart (DE)

(72) Inventors: Achim Neubauer, Sinzheim-Vormberg (DE); Martin Koehne, Asperg (DE); Christoph Schlensok, Lohr-Pflochsbach (DE); Thomas Finken, Wertheim (DE)

(21) Appl. No.: 16/625,738

(22) PCT Filed: Apr. 17, 2018
(86) PCT No.: PCT/EP2018/059739

§ 371 Date: Dec. 22, 2019

(30) Foreign Application Priority Data
Jun. 21, 2017 (DE) 10 2017 210 441.4

(51) Int. Cl. H01F 27/28; H01F 27/32; H01B 1/04; H02K 3/02; H02K 3/32; H01F 5/06

(52) U.S. Cl. CPC H01F 27/2847; H01F 27/32; H01F 5/06; H02K 3/02; H02K 3/325; H01B 1/04

(57) ABSTRACT

Electromagnetically excitable coils which are each formed by winding an electrical conductor which comprises graphene and/or carbon nanotubes are already known. According to the invention, the coil can be produced with a conductor strip in such a way that a winding space which is available to the coil is utilized in an optimum manner. According to the invention, provision is made for the at least one electrical conductor (2) to be designed as a conductor strip and to be wound in such a way that its conductor cross section is folded and/or angled over a certain length.

### BACKGROUND OF THE INVENTION

The invention is based on an electromagnetically excitable coil.

An electromagnetically excitable coil which is formed in each case by winding an electrical conductor which comprises graphene and/or carbon nanotubes is already known from DE 10 2007 063 413 A1.

### SUMMARY OF THE INVENTION

The electromagnetically excitable coil according to the invention having the characterizing features of the main claim has the advantage over the above that the coil can be produced with a conductor strip in such a way that a winding space which is available for the coil is utilized in an optimum manner. According to the invention, this is achieved by way of the at least one electrical conductor being designed as a conductor strip and wound in such a way that its conductor cross section is folded and/or bent over a certain length. Owing to the folding of the conductor cross section of the conductor strip in sections, steps can be formed in the winding in order to achieve a trapezoidal coil which utilizes the winding space in an optimum manner. Owing to the bending and/or folding of the conductor strip in sections, the winding space can be wound by the conductor strip in an optimum manner even if the n-fold width of the conductor strip is greater than the winding space width. Therefore, the invention renders possible the use of the same conductor strip for different winding space widths. If the coil is of, for example, trapezoidal design, the lowermost or innermost layers can be wound in a bent manner, while layers which are situated further on the outside fit precisely between the tooth head and the yoke and therefore are not folded or bent. The outermost layers are then, for example, folded in order to approximate the trapezoidal contour as the ideal winding geometry of the coil in an optimum manner and to achieve a maximum fill level.

According to one advantageous embodiment, the conductor strip is partially or completely sheathed with an electrical insulation. The insulating sheath can be produced, in particular, from a polymer.

It is particularly advantageous when the conductor strip has a bottom side and a top side, wherein only one of these two sides is provided with the electrical insulation. In this way, the fill factor of the coil can be increased and insulation material can be saved.

It is further advantageous when a plurality of electrically parallel conductor strips are wound for forming the coil. In this way, a coil which comprises a plurality of parallel electrical conductors is achieved in a simple manner.

It is highly advantageous when certain layers of the same conductor strip or layers of different conductor strips overlap one another, in particular in such a way that a step is bridged. In this way, a largely trapezoidal external geometry can be created for the wound coil, which external geometry manages without individual protrusions—as is customary in the case of windings using wire. In order to further optimize this on the process side, subsequent calibration of the wound coil can be carried out in the conductor strip region, this pressing the conductor strips by way of the step against the conductor track situated therebeneath and equalizing protrusions due to inaccuracies during winding and also compressing the multilayer conductor tracks.

It is also advantageous when the coil is wound onto an insulating element which is an insulation paper, a coating or a coil former and has, on its periphery, a certain, in particular wave-like or sawtooth-shaped, contour. In this way, an accordingly corresponding contour can be impressed onto the conductor strip, which contour firstly propagates over the layers of the conductor strip and leads to an ordered layer structure with the highest fill factor and secondly can be matched to different widths of the conductor strip for the same tooth geometry. The contour of the insulating element renders possible the use of different conductor cross sections, so that different characteristic curves can be achieved with the same segment geometry. Owing to the ideal matching of the super-thin conductor strips to the contour of the insulating element, different characteristic curves can be achieved with the same tooth segment and different conductor strip widths, specifically in such a way that, for example, the moment at the corner point rises with the conductor strip width and the field weakening region drops more sharply. If conductor strips which are insulated on one side are used, at least two different characteristic curves can be achieved by the contour of the insulating element even with the same conductor strip width by way of, in one case, the conductor strips being wound one onto the other such that two successive conductors are insulated from one another and in the other case such that they are short-circuited—that is to say therefore have twice the conductor cross section and therefore a different characteristic curve.

Furthermore, it is advantageous when the ends of each electrical coil are connected to ends of other coils, in particular are knotted, twisted or connected by van der Waals forces. The electrical connection of the coils is simplified in this way.

### BRIEF DESCRIPTION OF THE DRAWINGS

Two exemplary embodiments of the invention are illustrated in simplified form in the drawing and explained in more detail in the following description.

FIG. 1 shows, in section, a coil according to a first exemplary embodiment, and

FIG. 2 shows a coil according to a second exemplary embodiment.

### DETAILED DESCRIPTION

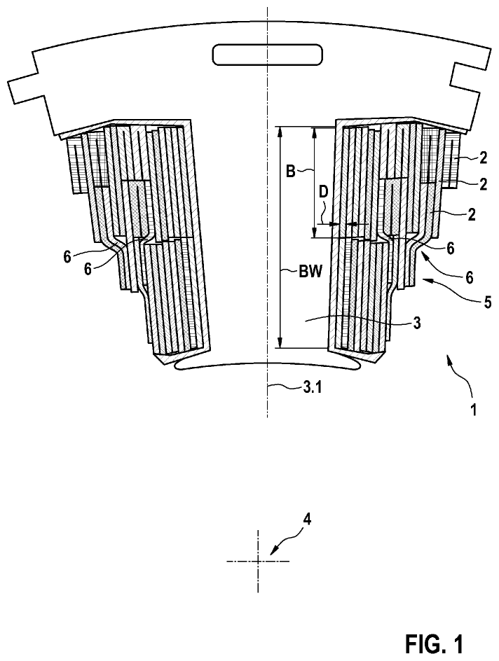

FIG. 1 shows, in section, a coil according to a first exemplary embodiment.

The electromagnetically excitable coil 1 is formed by winding at least one electrical conductor 2 which comprises graphene and/or carbon nanotubes. A single electrical conductor 2 can be provided or a plurality of electrically parallel conductors 2 can be wound so as to lie one over the other for forming the coil. The coil 1 surrounds, for example, a coil core 3 which can be, for example, a tooth of a stator or rotor laminated core of an electrical machine and has a core axis 3.1 which runs in the direction of the longitudinal extent of the coil core 3. In the case of an electrical machine, the core axis 3.1 runs in the radial direction with respect to a stator and/or rotor axis 4. The coil core 3 is designed, for example, in a customary manner as a laminate stack.

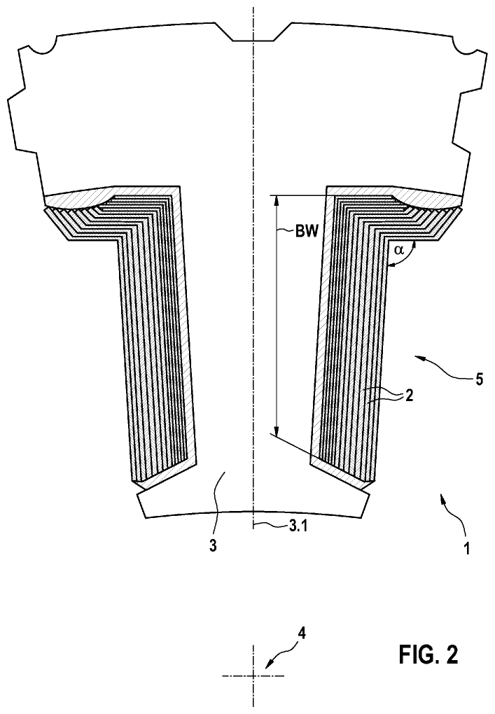

According to the invention, provision is made for the at least one electrical conductor 2 of the coil 1 to be designed as a conductor strip and wound in such a way that its conductor cross section is folded (FIG. 1) and/or bent (FIG. 2) over a certain length. In this way, the conductor strip 2 can be wound up in such a way that a winding space 5 which is available for the coil 1 is utilized in an optimum manner and a high fill factor is achieved for use in an electrical machine. The winding space 5 has a winding space width BW, which is measured in the direction of the core axis 3.1, and a winding space height, which is measured transversely in relation to the core axis 3.1. The conductor strip 2 is designed as a flat strip which has a width B and a thickness D, wherein the width B is several times greater than the thickness D. Owing to the folding or bending of the conductor cross section, the n-fold width of the conductor strip 2 can be greater than the winding space width BW or than a minimum and/or maximum value of the winding space width BW, for example where n=1, when the layers of the conductor strip 2 are wound exclusively one over the other in the direction transverse to the core axis 3.1 and not next to one another, or where n>1, when the layers of the conductor strip are arranged next to one another n-fold and are wound one over the other.

The folded conductor cross section of the conductor strip 2 is folded over through 180 degrees in accordance with the first exemplary embodiment. For example, the conductor cross section of the conductor strip 2 is folded over through 180 degrees in its center, so that the folded limbs of the conductor cross section of the conductor strip 2 are of equal length. However, the conductor cross section of the conductor strip 2 can also be folded in an asymmetrical manner, so that the folded limbs of the conductor cross section of the conductor strip 2 are of unequal length. The folding of the conductor cross section of the conductor strip 2 runs over one or more complete turns, that is to say turns which run over 360 degrees, so that a coil 1 which is substantially symmetrical with respect to the core axis 3.1 is produced.

The conductor strip 2 is formed from a composite of fibers. The fibers of the conductor strip 2 contain carbon nanotubes and/or a large number of layers of graphene. In particular, the fibers of the conductor strip 2 are produced from carbon nanotubes and/or from a large number of layers of graphene. The conductor strip 2 has an electrical insulation which can consist of or can be produced from a polymer and can be embodied as a sheathing. The conductor strip 2 has a bottom side and a top side, in each case with the width B, wherein only one of these two sides can be provided with the electrical insulation in order to electrically insulate the layers of the conductor strip 2, which layers are situated against one another, from one another. In addition, in each case two conductor strips 2 which are insulated on one side can be wound one onto the other such that the non-insulated sides come to lie one on the other in the region of a tooth neck of the tooth 3, for example due to 180° rotation in the winding head region.

Certain layers of the same conductor strip 2 or certain layers of different conductor strips 2 can overlap one another, in particular in such a way that a step 6 in the winding of the coil 1 is bridged.

The coil 1 is wound, for example, onto an insulating element 8 which can be an insulation paper, a coating or a coil former. This insulating element 8 can have, on its periphery, a certain, in particular wave-like or sawtooth-shaped, contour to which the conductor strip, on account of its low thickness and its flexural yield, is matched in a corresponding manner in such a way that this contour of the insulating element 8 propagates over all layers of the conductor strip 2. Owing to the matching of the conductor strip 2 to the contour of the insulating element 8, the coil 1 has a smaller width than the flat conductor strip 2.

FIG. 2 shows a coil according to a second exemplary embodiment. In the case of the coil according to FIG. 2, the parts which remain the same or act the same way as the coil according to FIG. 1 are identified using the same reference symbols.

In the case of the second exemplary embodiment, the layers of the conductor strip 2 are wound exclusively one over the other where n=1 and the width of the conductor strip 2 is greater than the winding space width BW. In order to nevertheless be able to use the conductor strip 2 with this width, the conductor cross section of the conductor strip 2 is bent through an angle α, for example, over all layers and, for example, at the foot of the coil core 3. The benefit of targeted geometries of this kind can be found in the matching to available winding spaces. In the present case, an insulating body, for example a plastic separating wing, is inserted between adjacent wound coils in order to absolutely reliably prevent short-circuits in the formed geometry cutout of the winding, said insulating body terminating flush with the insulating element radially on the inside and radially on the outside and being radially fixed by the geometry.

In accordance with the two exemplary embodiments according to FIG. 1 and FIG. 2, the coil according to the invention can be provided on each of the teeth of a rotor or of a stator of an electrical machine. For example, the arrangement shown in FIG. 1 or FIG. 2 can be arranged several times in succession in the circumferential direction with respect to the axis 4 in order to form a stator. On the electrical machine, the ends of each electrical coil 1 are connected to ends of other coils 1, in particular knotted, twisted or connected by van der Waals forces. As an alternative, continuous winding between adjacent coils of the same phase is possible.

1. An electromagnetically excitable coil (1) which is formed by winding at least one electrical conductor (2) which comprises graphene and/or carbon nanotubes, characterized in that the at least one electrical conductor (2) is configured as a conductor strip having a conductor cross section, wherein the conductor strip is wound in such a way that the conductor cross section is folded and/or bent over a certain length.

2. The coil as claimed in claim 1, characterized in that the conductor strip (2) has an electrical insulation.

3. The coil as claimed in claim 2, characterized in that the conductor strip (2) has a bottom side and top side, wherein only one of the bottom side and the top side is provided with the electrical insulation.

4. The coil as claimed in claim 1, characterized in that a plurality of electrically parallel conductor strips (2) are wound for forming the coil (1).

5. The coil as claimed in claim 3, characterized in that an other of the bottom side and the top side is non-insulated, and in each case two conductor strips (2) which are insulated on one side are wound one onto the other such that the non-insulated sides come to lie one on the other.

6. The coil as claimed in claim 4, characterized in that certain layers of the same conductor strip (2) or layers of different conductor strips (2) overlap one another.

7. The coil as claimed in claim 1, characterized in that the coil (1) is wound onto an insulating element (8) which is an insulation paper, a coating or a coil former and which has, on a periphery, a certain contour.

8. The coil as claimed in claim 1, characterized in that the conductor strip (2) is a flat strip which has a width (B) and a thickness (D), wherein the width (B) is several times greater than the thickness (D).

9. The coil as claimed in claim 1, characterized in that the conductor strip (2) is a composite of fibers which comprise carbon nanotubes and/or a large number of layers of graphene.

10. An electrical component of an electrical machine, with teeth (3) on each of which a coil (1) as claimed in claim 1 is provided.

11. The electrical component as claimed in claim 10, characterized in that ends of each electrical coil (1) are connected to ends of other coils (1).

12. The coil as claimed in claim 1, characterized in that the conductor strip (2) has an electrical insulation composed of a polymer.

13. The coil as claimed in claim 4, characterized in that certain layers of the same conductor strip (2) or layers of different conductor strips (2) overlap one another in such a way that a step (6) in the winding is bridged.

14. The coil as claimed in claim 1, characterized in that the coil (1) is wound onto an insulating element (8) which is an insulation paper, a coating or a coil former and which has, on a periphery, a wave-like or sawtooth-shaped contour.

15. The coil as claimed in claim 1, characterized in that the conductor strip (2) is a flat strip which has a width (B) and a thickness (D), wherein the width (B) is at least three times greater than the thickness (D).

16. The electrical component as claimed in claim 10, characterized in that ends of each electrical coil (1) are connected to ends of other coils (1) by knotting, by twisting, or by van der Waals forces.
